(19) United States
(12) Patent Application Publication
(10) Pub. No.: US 2017/0084200 A1
(43) Pub. Date: Mar. 23, 2017

(54) Educational Card Game

(71) Applicant: Margaret Wattenhofer, Park Rapids, MN (US)

(72) Inventor: Margaret Wattenhofer, Park Rapids, MN (US)

(21) Appl. No.: 14/859,825

(22) Filed: Sep. 21, 2015

(51) Int. Cl. G09B 19/22; A63F 1/02; G09B 17/00

(52) U.S. Cl. CPC G09B 19/22; G09B 17/00; A63F 1/02

(57) ABSTRACT

An educational card game includes a plurality of cards defining a deck of cards. Each of the cards has indicia thereon. The indicia comprise a letter or a word and each of the indicia is unique to no greater than four of the cards such that no more than four of the cards have the same indicia positioned thereon. A plurality of holders is provided and each holds a number of the cards in a vertical orientation.

### BACKGROUND OF THE DISCLOSURE

### Field of the Disclosure

The disclosure relates to alphabet teaching devices and more particularly pertains to a new alphabet teaching device for assisting a person or teacher in teaching the alphabet to a child.

### SUMMARY OF THE DISCLOSURE

An embodiment of the disclosure meets the needs presented above by generally comprising a plurality of cards defining a deck of cards. Each of the cards has indicia thereon. The indicia comprise a letter or a word and each of the indicia is unique to no greater than four of the cards such that no more than four of the cards have the same indicia positioned thereon. A plurality of holders is provided and each holds a number of the cards in a vertical orientation.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front perspective view of a educational card game according to an embodiment of the disclosure.

FIG. 2 is a front view of an embodiment of the disclosure.

FIG. 3 is a step diagram of an embodiment of the disclosure.

FIG. 4 is a front perspective view of an embodiment of the disclosure.

### DESCRIPTION OF THE PREFERRED EMBODIMENT

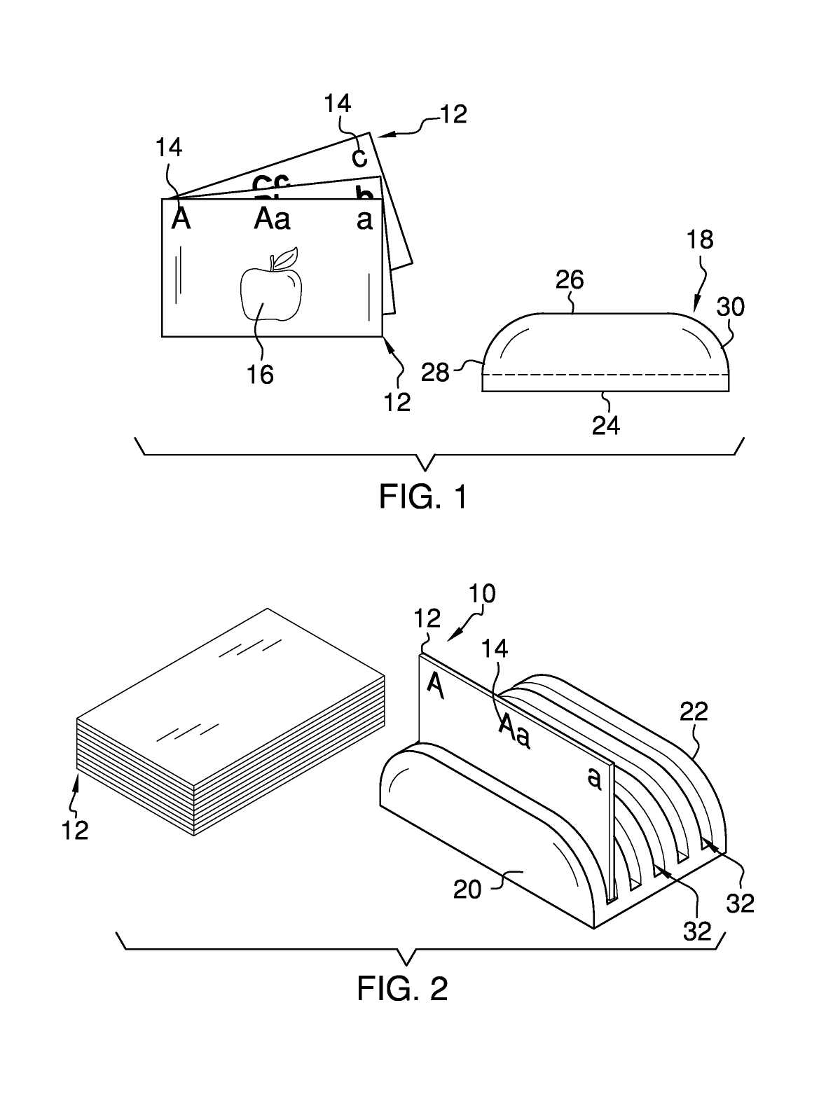

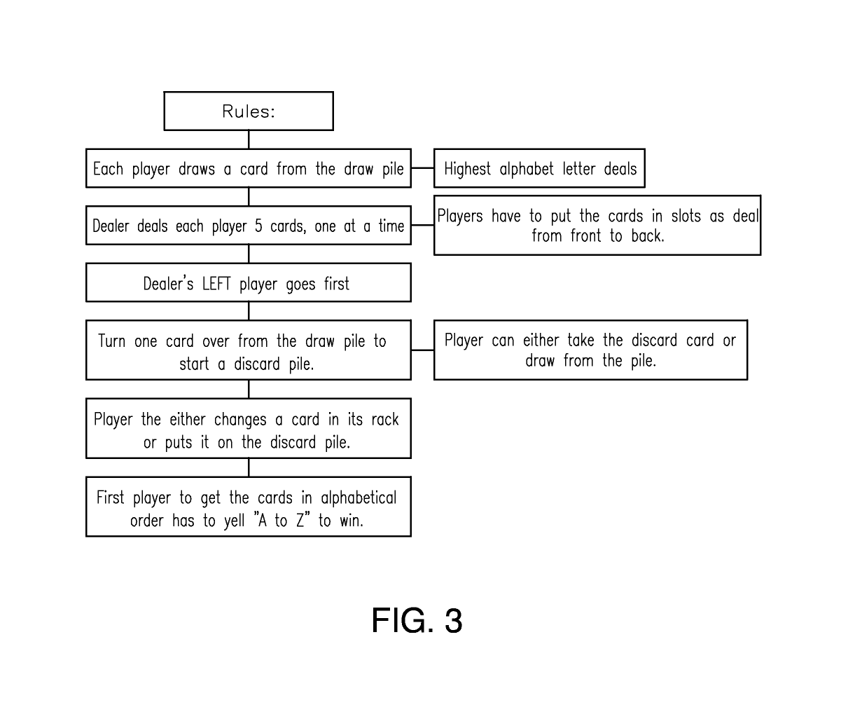

With reference now to the drawings, and in particular to FIGS. 1 through 4 thereof, a new alphabet teaching device embodying the principles and concepts of an embodiment of the disclosure and generally designated by the reference numeral 10 will be described.

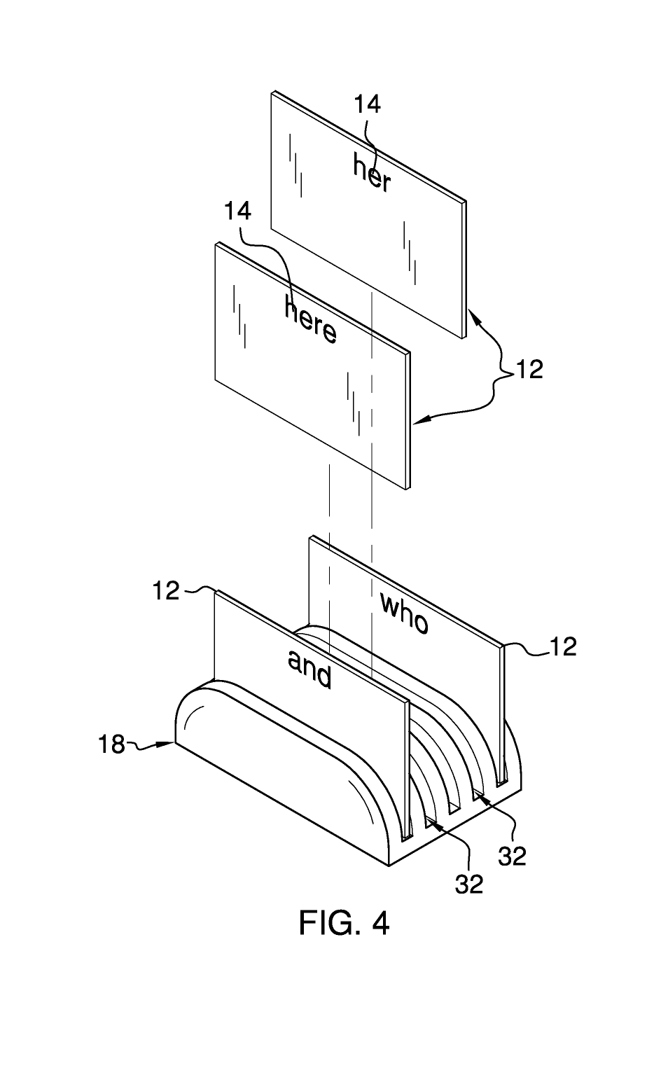

As best illustrated in FIGS. 1 through 4, the educational card game 10 generally comprises a plurality of cards 12 defining a deck of cards. Each of the cards 12 has indicia 14 thereon wherein the indicia 14 may comprise a letter, as shown in FIG. 1, or a word, as shown in FIG. 4. Each of the indicia 14 is unique to each card 12. The indicia 14 may be a single letter, such as A, B, C, etc. while the words may be age specific “sight” words comprising words typically used by an age group. The indicia 14 is unique to each card 12 so that the cards may be placed in alphabetical order. However, the card game 10 may provide cards wherein each indicia 14 may be repeated up to no more than four times to allow for a larger deck of cards 12. Where only single letters are provided, the entire alphabet may be used and may be repeated depending on the amount of cards 12 required or decided upon. Thus if there are two of each letter, in the English language, fifty-two cards 12 will be provided.

Each of the cards 12 may be provided further with an image 16 thereon corresponding to the indicia 14 on an associated one of the cards. Thus, if the indicia 14 comprises a full word, the image 16 may correspond to the full word. If the indicia 14 comprises a single letter, the image 16 will correspond to a word starting with that letter. For example, if the letter is an “A” the image 16 may be of an apple as shown in FIG. 1.

A plurality of holders 18 is provided and each is configured for holding a number of the cards 12 in a vertical orientation. Though only one holder 18 is shown, the game 10 will typically include at least four holders 18. The number of cards 12 may be five cards 12 though other numbers as low as four and as high as ten may be utilized. Each holder 18 has a front side 20, a back side 22, a bottom side 24, a top side 26, a first lateral side 28 and a second lateral side 30. The top side 26 has a plurality of slots 32 therein extending towards the bottom side 24. Each of the slots 32 removably receives one of the cards 12. The cards 12 each have a height greater than a depth of the slots 32 such that the indicia 14 are viewable when the cards 12 are placed in the slots 32. Each of the slots 32 extends through each of the first 28 and second 30 lateral sides. The plurality of slots 32 may be five slots 32 as indicated above.

In use, the cards 12 may be used in any number of ways to teach a child the alphabet as well as common words. Typically the game 10 will be played by a plurality of the cards 12 being dealt to each player, such as five to each player. The players then take turns drawing and discarding cards 12 from the remaining cards and from a discard pile. Once a player has five cards 12 which are in alphabetical order without any gaps or doubles of the letters, that player wins. However, variations of the above may exist as the intent is simply to teach alphabetization and therefore any rules which support this goal may be entertained. The cards 12 are placed in the slots 32 while they are organized into alphabetical order.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An educational card game configured for teaching word and letter recognition, said card game comprising:
a plurality of cards defining a deck of cards, each of said cards having indicia thereon, said indicia comprising a letter or a word, each of said indicia being unique to no greater than four of said cards; and
a plurality of holders each configured for holding a number of said cards in a vertical orientation.

2. The educational card game according to claim 1, wherein each of said cards has an image thereon corresponding to said indicia on an associated one of said cards.

3. The educational card game according to claim 1, wherein each of said holders includes:
a front side, a back side, a bottom side, a top side, a first lateral side and a second lateral side, said top side having a plurality of slots therein extending towards said bottom side, each of said slots removably receiving one of said cards, each of said cards having a height greater than a depth of said slots such that said indicia is viewable when said cards are placed in said slots.

4. The educational card game according to claim 3, wherein each of said slots extends through each of said first and second lateral sides, said plurality of slots being five slots.

5. An educational card game configured for teaching word and letter recognition, said card game comprising:
a plurality of cards defining a deck of cards, each of said cards having indicia thereon, said indicia comprising a letter or a word, each of said indicia being unique to each card;
each of said cards having an image thereon corresponding to said indicia on an associated one of said cards;
a plurality of holders each configured for holding a number of said cards in a vertical orientation, each of said holders having:
a front side, a back side, a bottom side, a top side, a first lateral side and a second lateral side, said top side having a plurality of slots therein extending towards said bottom side, each of said slots removably receiving one of said cards, each of said cards having a height greater than a depth of said slots such that said indicia is viewable when said cards are placed in said slots, each of said slots extending through each of said first and second lateral sides, said plurality of slots being five slots.
